(19) United States
(12) Patent Application Publication
(10) Pub. No.: US 2020/0377338 A1
(43) Pub. Date: Dec. 3, 2020

(54) ELEVATOR DRIVE UNIT

(71) Applicant: thyssenkrupp Elevator Innovation and Operations GmbH, Essen (DE)

(72) Inventors: Alexander WÖLFEL, Stuttgart (DE); Kai HANSEN, Stuttgart (DE); Martin SCHÜTT, Leinfelden-Echterdingen (DE); Roland NÄGELE, Stuttgart (DE); Felix EISELE, Esslingen (DE); Dirk BURKHARDT, Geislingen (DE)

(73) Assignee: thyssenkrupp Elevator Innovation and Operations AG, Essen (DE)

(21) Appl. No.: 16/766,356

(22) PCT Filed: Dec. 19, 2018
(86) PCT No.: PCT/EP2018/085901

§ 371 Date: May 22, 2020

(30) Foreign Application Priority Data
Dec. 19, 2017 (DE) 10 2017 223 246.3
Dec. 19, 2017 (DE) 10 2017 223 260.9

(51) Int. Cl. B66B 11/04; B66B 1/36; B66B 11/08; B66B 11/00

(52) U.S. Cl. CPC B66B 11/043; B66B 11/0035; B66B 11/08; B66B 1/36

(57) ABSTRACT

An elevator drive unit includes a drive shaft having at least one drive section for driving a drive belt. The drive unit also includes an electromotor, for driving the drive shaft having a stator and a rotor, a brake for braking the drive shaft, and a frame for supporting the drive shaft, the stator and the brake.

The invention refers to an elevator drive unit.

EP 0 753 928 B1 discloses an electric motor in skeletal mode of construction. It comprises flanges, which extend traversly to the motor shaft. Openings are arranged concentrically relative to the motor shaft. The flanges and ribs form a load bearing motor skeleton. The motor is adapted to drive a rope for suspending an elevator car; the dimensions of the motor and the drive sheave for driving the rope are quite large.

It is an object to providing an improved elevator drive unit. This is solved by the elevator drive unit according to claim 1; embodiments are disclosed in the subclaims and the description.

The inventive elevator drive unit comprises

a drive shaft, having at least one drive section for driving a drive belt,

an electromotor, for driving the drive shaft, having a stator and a rotor,

a brake for braking the drive shaft,

a frame for supporting the drive shaft, the stator and the brake.

In an embodiment the frame comprises a bridging section, axially bridging the stator; the bridging section comprises a ventilating opening, on or in which a ventilating unit is provided. In particular the ventilating unit is adapted to ventilate the stator The frame is consequently used for positioning the ventilating unit. No further fixing means are required.

In an embodiment the brake comprising a rotating first brake partner, in particular a rotating brake disc with a brake pad on it. The drive unit comprises a brake shield, the brake shield comprising a non-rotating second brake partner, in particular a brake disc, interacting with the rotating first brake partner, the brake shield connects the stator an the brake with the frame.

The brake shield is thus a common connecting element between the stator, the brakes and the frame. This triangle relationship enables small chain of tolerances between the frame, the brakes and the stator. The brake shield can be easily aligned with the axis of rotation of the drive shaft on the one hand; the brakes and the stator can be easily aligned relative to each other and relative to the frame via the brake shield. Thus high accuracy alignment is enabled with easy methods.

In an embodiment the frame comprises a first bearing support and a second bearing support. In particular the frame elevator unit comprises exactly two bearing supports. Each bearing support is adapted to accommodate a bearing of the drive shaft,

the first bearing support is located axially between the second bearing support and the stator.

The stator and consequently the brake thus arranged axially outside of the space between the both bearings. In an embodiment the brake shield is located axially between the brake and the stator.

In an embodiment the stator is fixed to the frame on a side of the stator axially opposite to the first bearing support and the second bearing support.

In an embodiment the frame comprises a bridging section, axially bridging the stator.

In particular, the stator located radially free relative to the frame in particular the bridging section. So there is in particular a radial gap between the bridging section and the stator over the entire length of the stator, enabling minimum radial movement of the stator relative to the frame, in particular for alignment reasons.

In an embodiment the frame comprises two bridging sections located on a radially opposite side of the stator. Even under consideration of the exposed position of the brake shield relative to the bearings the brake shield can be mounted with a high degree of position stability.

In an embodiment the bridging section comprises a ventilating opening, in particular on or in which a ventilating unit is provided. The bridging section is thus a mounting device for the ventilating unit.

An inventive elevator installation comprises an elevator drive unit according to any of the preceding claims. The elevator installation may further comprise a cabin arranged within an elevator shaft. The cabin may be guided by guide rails, installed in the elevator shaft. The cabin is supported by a drive belt. The drive belt is driven by the elevator drive unit.

The elevator drive unit is particularly gearless. In particular between the rotor the drive sections are arranged on the same single shaft, which does not mean the shaft is essentially made from one single part.

The invention is explained in more detail with the help of the attached figures, herein shows schematically:

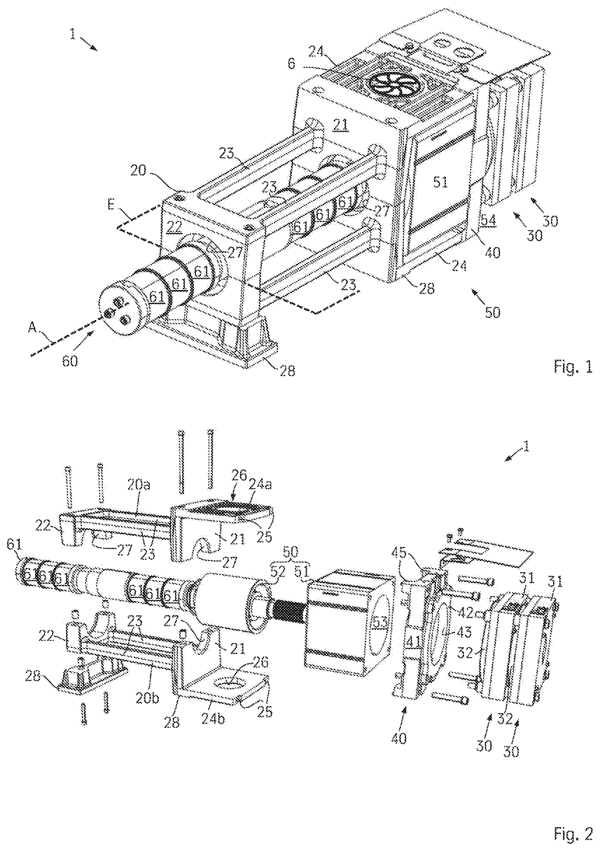

FIG. 1 an inventive elevator drive unit in perspective view;

FIG. 2 the elevator drive unit of FIG. 1 in exploded view;

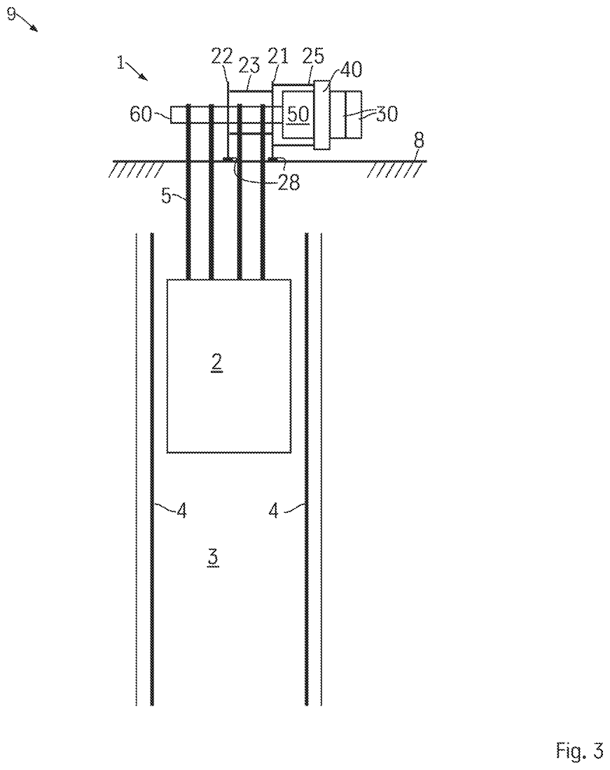

FIG. 3 an inventive elevator installation having an elevator drive unit of FIG. 1.

FIG. 3 shows an inventive elevator installation drive unit 1. The elevator installation 9 comprises a cabin 2 arranged within an elevator shaft 3. The cabin 3 is guided by guide rails 4, installed in the elevator shaft 3. The cabin 2 is supported by a drive belt 5. The drive belt is driven by an inventive elevator drive unit 1. The elevator drive unit is shown in more detail in FIGS. 1 and 2.

The inventive drive unit 1 comprises a drive shaft 60, which comprises several drive section 61, around which driving the drive belt 5 (FIG. 1) is wound during operation. The transmission of force between the drive section and the belt may be based on friction or based on a form fit connection (positive fitting). In this embodiment there are six drive sections 61; the number can be varied. Furthermore, not all of the drive section 61 may be used during in a specific elevator installation.

The drive shaft 60 is driven by an electromotor 50. The electromotor comprises a rotor 52, which is fixedly connected to the drive sections 61. In an embodiment the rotor 52 can be an integral part of the drive shaft 60 or may be connected to the drive shaft 60 in any rotatably fixed manner. The electromotor 50 further comprises a stator 51.

The drive unit 1 comprises a brake 30. The brake 30 comprises an actuator, which is adapted to act upon at least one of two brake partners 32, 42 which rotate against each other. Here the second brake partner 42 is stationary; the first brake partner 32 is rotatably fixed to the drive shaft 60.

In this specific embodiment the first one of the brake partners 32 is a rotating brake disc with brakes pads on it; the second brake partner is a non-rotating brake disc 42. In particular the brake pad wears off more quickly than the other brake disc.

During a brake application the first braking partner 32 is urged axially into the direction of the second brake partner 42, resulting in a decelerating torque acting on the drive shaft 60.

The fixed second brake partner 41 is fixedly connected to a brake shield 40, in particular the second brake partner 42 is an integral part of the brake shield 40. The brake shield 40 itself is connected to the frame 20 in a non-rotational manner. So during a brake application the brake shield 40 is applied with torque by the brake 30 itself and the rotating first brake partner 51.

The brake shield transmits the resulting torque into the frame 20.

The brake shield 40 is located axially between the brake 30 and the electromotor 50.

All the components mentioned before are supported at least indirectly by a support frame 20.

The support frame 20 comprises a first bearing support 21 and a second bearing support 22. In a bearing recess 27 of each bearing support 21, 22 a bearing (not shown) of the drive shaft 60 is held radially fixed and in an axially fixed or axially floating manner. The bearing supports 21, 22 are located on one side of the electromotor 50, so that with respect to the bearings supports 21, 22 the electromotor 50 is located in an overhanging way. Vertically below each bearing support, in particular vertically below the bearing recesses 27 the drive unit comprises an optional stand 28 for attaching the frame 20 to a supporting structure of the elevator installation, in particular a mounting plate 8 (FIG. 3).

The bearing supports 21, 22 are arranged within an axial distance and are connected to each other by connecting bars 23. In this specific embodiment four connecting bars 23 are provided.

The connecting bars 23 axially bridge several drive sections 23.

At the first bearing support 21 a bridging section 24 is provided. The bridging section 24 projects axially in the direction of the brakes 30 and the electromotor 50. The bridging section 24 bridges the entire length of the stator 51, to constitute a supporting connection between the brake shield 40 and the first bearing support 21. So the brake and in particular the stator is exclusively supported by the frame 20 via the bridging section 24.

The frame 20 is made from two parts, here an upper frame part 20a and a lower frame part 20b. A splitting plane E is in particular arranged horizontally. An axis of rotation of the drive shaft 60 lies within the splitting plane A.

The stands 28 can be an integral part of the lower frame part or, as shown here, an additional separate part of the frame 20.

The brake shield 40 is connected to the bridging section 24 by first screws. The exact positioning of the brake shield 40 relative to the bridging section 24 is performed in a form fitting way with the help of first positioning edges 25 at the bridging section 24 and second position edges 45 at the brake shield 40. The first positioning edges 25 are manufactured, in particular milled, in a highly accurate quality relative to the bearing recess 27, which are also milled. The second positioning edges 45 are manufactured, in particular milled, in a highly accurate quality relative a central opening 43 of the brakeshield. Consequently a central axis of the central opening 43 of the brake shield 40 is aligned with very small tolerances relative to the axis of rotation A of the drive shaft 60, which is defined by the bearing recesses 27.

The stator 51 needs also to be aligned to the axis of rotation. Hereby no accurate positioning edges between the stator 51 and brake shield 40 are provided. The alignment of the stator 51 is performed with the help of an alignment mandrel (not shown). The alignment mandrel is protruded into the central opening 43 of the brake shield 40 and at the same time into a central opening 53 of the stator 51. After alignment between the stator 51 and the brake shield 40 second screws 72 are tightened to fix the alignment between the brake shield 40 and the stator 51 in a non-positive manner.

By aligning the stator 51 to the well aligned brake shield 40, the stator 51 can be positioned very accurately with small tolerances to the axis of rotation.

Since the brake shield 40 is located between the brake 30 and the stator 51, and the stator as well as the brakes are precisely aligned with the brake shield 40, a small chain of tolerances is given between the brake 30 and the stator 51. A small chain of tolerances enables in particular the usage of cheaper components and/or or of easier assembly methods.

### LIST OF REFERENCE SIGNS

1 drive unit
2 cabin
3 elevator shaft
4 rail
5 drive belt
6 ventilating unit
8 mounting plate
9 elevator installation
20 frame
20a upper frame part
20b lower frame part
21 first bearing support
22 second bearing support
23 connecting bar
24 bridging section
25 first positioning edge
26 ventilating opening
27 bearing recess
28 stand
30 brake
31 brake housing
32 rotating first brake partner/brake disc
40 brake shield
41 brake shield housing
42 fixed second brake partner/brake disc
43 central opening of brake shield
45 second positioning edge
50 electromotor
51 stator
52 rotor
53 central opening of stator
54 side of stator opposite the first and second bearing support
60 drive shaft
61 drive section
71 first screw
80 stand
E splitting plane
A axis of rotation

1.-11. (canceled)

12. An elevator drive unit, comprising:
a drive shaft, including a drive section configured to drive a drive belt,
an electromotor configured to drive the drive shaft, the electromotor including a stator and a rotor,
a brake configured to brake the drive shaft, and
a frame configured to support the drive shaft, the stator and the brake.

13. The elevator drive unit of claim 12 wherein the brake includes a rotating first brake partner.

14. The elevator drive unit of claim 13 wherein the drive unit comprises a brake shield, the brake shield comprising a non-rotating second brake partner interacting with the rotating first brake partner, and wherein the brake shield connects the stator.

15. The elevator drive unit of claim 14 wherein the brake shield is located axially between the brake and the stator.

16. The elevator drive unit of claim 12 wherein the frame comprises a bridging section axially bridging the stator, and the bridging section comprises a ventilating opening, on or in which a ventilating unit is provided.

17. The elevator drive unit of claim 16 wherein the ventilating unit is configured to ventilate the stator.

18. The elevator drive unit of claim 12 wherein the frame comprises a first bearing support and a second bearing support, each bearing support configured to accommodate a bearing of the drive shaft, the first bearing support located axially between the second bearing support and the stator.

19. The elevator drive unit of claim 18 wherein the stator is fixed to the frame on a side of the stator axially opposite to the first bearing support and the second bearing support.

20. The elevator drive unit of claim 12 wherein the frame comprises a bridging section axially bridging the stator.

21. The elevator drive unit of claim 20 wherein the frame comprises two bridging sections located on a radially opposite side of the stator.

22. An elevator installation, comprising the elevator drive unit of claim 12.
